(19) United States
(12) Patent Application Publication
(10) Pub. No.: US 2017/0053354 A1
(43) Pub. Date: Feb. 23, 2017

(54) LICENSING MANAGER

(71) Applicant: Revolution Group, Inc., Westerville, OH (US)

(72) Inventors: Michael A. Ravagnani, Westerville, OH (US); Kevin D. Rall, Crestline, OH (US)

(21) Appl. No.: 15/241,933

(22) Filed: Aug. 19, 2016

Related U.S. Application Data
(60) Provisional application No. 62/208,254, filed on Aug. 21, 2015.

(51) Int. Cl. G06Q 40/08

(52) U.S. Cl. CPC G06Q 40/08

(57) ABSTRACT

A system for facilitating automatic license request forms for an insurance carrier. A carrier component manages information of producers, policies, and customers. A license manager facilitates administration of a plurality of producer licenses. The license manager receives existing producer license information from a producer registration system. The license manager further populates a license request form with the received producer license information and producer information from the carrier component. The license manager sends the license request form to the producer registration system. The producer registration system requests a license or license termination from the associated state licensing entity.

### CROSS REFERENCE TO RELATED APPLICATIONS

This application claims priority to U.S. Provisional Patent application Ser. No. 62/208,254 entitled “LICENSING MANAGER” and filed Aug. 21, 2015. The entirety of the above-noted application is incorporated by reference herein.

### BACKGROUND

Insurance producers interact with insurance carriers to provide information regarding licensing procedures. Conventionally, the information is manually shared between the producer and the carrier where the producer manually provides their license information to the carrier as well as to a separate producer registration system. Providing the information manually is time consuming for insurance carriers and insurance producers and creates large amounts of overhead.

### SUMMARY

The following presents a simplified summary of the subject innovation in order to provide a basic understanding of some aspects of the subject innovation. This summary is not an extensive overview of the subject innovation. It is not intended to identify key/critical elements of the subject innovation or to delineate the scope of the subject innovation. Its sole purpose is to present some concepts of the subject innovation in a simplified form as a prelude to the more detailed description that is presented later.

The subject innovation disclosed and claimed herein, in aspects thereof, comprises systems and methods that can manage license processes for insurance producers using the carrier and the producer registration system.

In aspects, a system, comprising a carrier component that manages information of producers; and a license manager that facilitates administration of a plurality of producer licenses. The license manager includes a retrieval component that receives existing producer license information from a producer registration system. The license manager further includes a forms component that populates a license request form with the received producer license information and producer information from the carrier component.

In other aspects, a method comprising receiving a producer request from a carrier; retrieving producer license information about a producer from a producer registration system; and populating a producer license request form with the retrieved producer license information and the missing information. The method includes determining missing information to be included in a producer license request form to be sent to the producer registration system; and retrieving missing information from the carrier to include in the producer license request form.

In further aspects, a computer readable medium having instructions for controlling one or more processors, the instructions comprising receiving a selection of states and lines of authority to request from the states. The instructions include retrieving producer license information in response to the selection associated with a producer account with a carrier; and converting the lines of authority selection into state specific codes indicating the lines of authority. The instructions further include populating a license request form with the producer license information and state specific codes.

The subject innovation provides advantages of providing one account that can manage sales for a producer as well as the licensing process. Another advantage is the elimination of outside vendors to navigate the licensing process. Yet another advantage is reduction of manually completing licensing form in multiple entities.

To the accomplishment of the foregoing and related ends, certain illustrative aspects of the subject innovation are described herein in connection with the following description and the annexed drawings. These aspects are indicative, however, of but a few of the various ways in which the principles of the subject innovation can be employed and the subject innovation is intended to include all such aspects and their equivalents. Other advantages and novel features of the subject innovation will become apparent from the following detailed description of the subject innovation when considered in conjunction with the drawings.

### BRIEF DESCRIPTION OF THE DRAWINGS

FIG. 1 illustrates a component diagram of a carrier component.

FIG. 2 illustrates a component diagram of a license manager and producer registration system in accordance with aspects of the subject innovation.

FIG. 3 illustrates a method of automatically generating producer license requests.

FIG. 4 illustrates a screenshot of a producer account to begin a license appointment request.

FIG. 5 illustrates a screenshot of a dialog to select carriers (writing companies) and states to be licensed.

FIG. 6 illustrates a screenshot of a dialog to select lines of authority to request from the state.

FIG. 7 illustrates a computer-readable medium or computer-readable device comprising processor-executable instructions configured to embody one or more of the provisions set forth herein, according to some embodiments.

FIG. 8 illustrates a computing environment where one or more of the provisions set forth herein can be implemented, according to some embodiments.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the subject innovation can be practiced without these specific details. In other instances, well-known structures and devices are shown in block diagram form in order to facilitate describing the subject innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

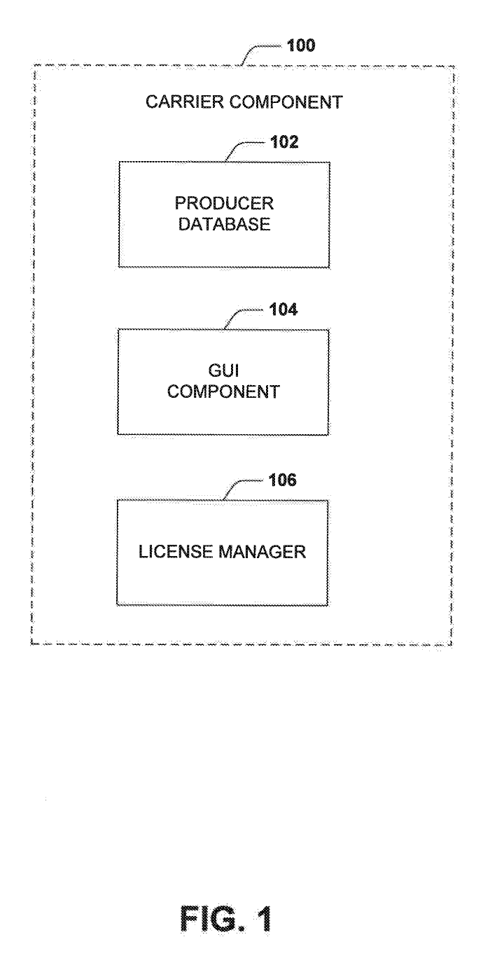

With reference to FIG. 1, a carrier component 100 is depicted. The carrier component 100 includes one or more processors that provide a web application that can facilitate an insurance carrier managing an insurance producer and/or agency (or a related type of entity). In various embodiments, the carrier component 100 can also include a web portal whereby a user can access information associated with the automation processes. Such a portal or page can provide information showing carriers (to which the system has access in connection with the user's data) information regarding data flow management, and provide the user the ability to manage associated options, provide access for automated information retrieval and database/form population, etc.

In various aspects, the carrier component 100 can include a producer database 102. The producer database 102 includes information about producers associated with the insurance carrier associated with the carrier component 100. In one embodiment, the producer database 102 can be integrated or operate in conjunction with a database such as one built on a Salesforce.com database or another customer relationship management solution database. The database can include a package with one or more objects that can modify the existing database to be focused more specifically on customer relationship management (CRM) solutions related to the insurance industry. Such modifications can include one or more data fields specific to the insurance industry, such as fields for account, policy or policies, coverage, etc. The carrier component 100 includes insurance policies and other information relating to an insurance carrier. In one embodiment, the carrier component 100 can be a database that is remotely located from an insurance carrier and accessed via a network.

The carrier component 100 includes a graphical user interface (GUI) component 104. The GUI component 104 can accept user inputs via a keyboard, mouse, touchscreen, and/or other user input mechanism. The GUI component 104 can provide the inputs for users to interact with forms, databases, and the like within the carrier component 100.

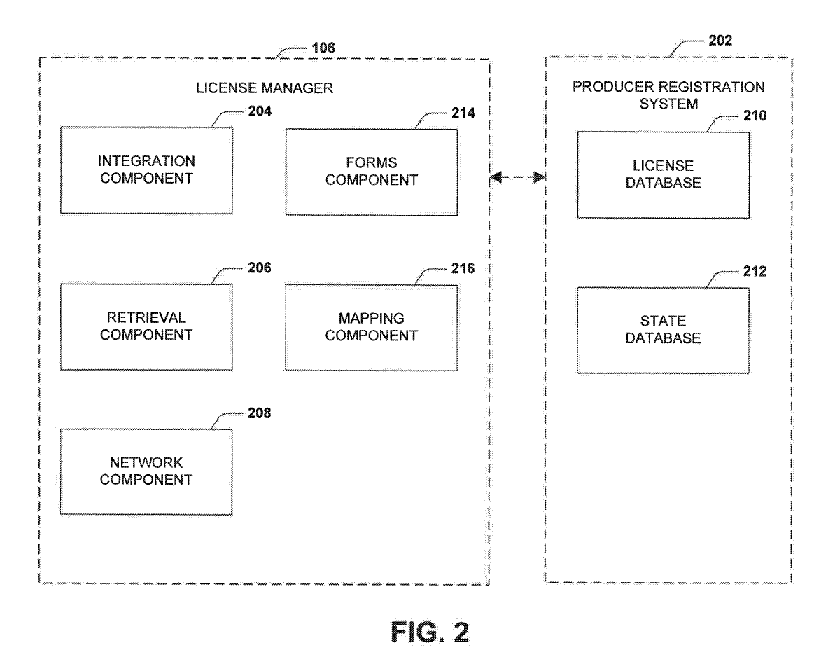

With reference to FIG. 2, and continuing reference to FIG. 1, the carrier component 100 includes a license manager 106. The license manager 106 administrates license appointments, terminations, and/or the like for state registration of insurance producers (a.k.a. producers) associated (or to be associated) with the carrier. The license manager 106 interacts with a producer registration system 202 to complete license administration forms which in turn are sent to a state licensing entity through the producer registration system 202. The producer registration system 202 is described in detail below.

The license manager 106 includes an integration component 204. The integration component 204 operates with the carrier component 100 to integrate the license manager 106 into the carrier component 100. For example, the license manager 106 is a separate entity of hardware and/or software that installs into the carrier component 100 such that two are seamlessly integrated. As another example, the license manager is an “add-on” entity installed with the carrier component 100 where the license manager utilizes the same framework and GUI 104 of the carrier component 100 while adding licensing administration functionality. The integration component 204 facilitates communication between the carrier component 100 and the license manager 106. In one embodiment, the license manager 106 is a separate entity that communicates with the carrier component 100 via API call, network protocols, and/or the like.

The license manager 106 includes a retrieval component 206. The retrieval component 206 can receive information directly from one or more producer registration systems 202. The retrieval component 206 receives producer licensing information from the producer registrations system 202. The retrieval component 206 can request information via API call/response, download request, network protocols, and/or the like. The retrieval component 206 can receive the producer information using a network component 208. The network component 208 can access the producer registration system 202 over transmission servers, wired local area networks (LANs), wireless LANs, mobile networks, and/or the like. In one embodiment, the retrieval component 206 can receive batch reports for multiple producers at once. In another embodiment, the retrieval component 206 can detect errors in the producer information and retrieve the producer information another time to correct the errors.

The retrieval component 206 can find a producer in the producer registration system 202 using a producer identifier such as a National Producer Number (NPN), an Employer Identification Number (EIN), or Social Security Number (SSN). An NPN is a unique identifier assigned through the licensing application process or reporting systems to individuals and business entities (including, but not limited to producers, adjusters, and navigators) engaged in insurance related activities regulated by a state insurance department. The NPN is used to track those individuals and business entities on a national basis. In one embodiment, the retrieval component 206 retrieves a producer detail data report.

The retrieval component 206 accesses databases in the producer registration system 202. The producer registration system 202 includes a license database 210. The license database 210 includes license information for producers. The license information can include states licensed, lines of authority (LOAs), producer registration numbers, and/or the like. In one embodiment, the retrieval component 206 can retrieve a pending license requests report to determine license requests that have been submitted to states. The producer registration system 202 includes a state database 212. The state database 212 includes state specific information. The state specific information can include requirements for each state that a producer must provide before being licensed to sell insurance in that state. The state specific requirements can include producer personal information, LOA codes, and/or the like. LOA codes are codes created by the state that indicate lines of authority for types of insurance the producer requests to be license to sell. For example, a LOA code can be “36” which translates to casualty insurance in Indiana.

In one embodiment, the producer registration system 202 is the National Insurance Producer Registry (NIPR). The retrieval component 206 can download the requirements, and license information from the NIPR. In one embodiment, the NIPR generates a producer report using a producer identifier. In one embodiment, the producer registration system 202 can charge an account for reports that cost money. In one embodiment, the retrieval component 206 stores the information in the producer database 102 of the carrier component 100 via the integration component 204.

The license manager 106 includes a forms component 214. The forms component 214 automatically populates a license request form using the information from the producer registration system 202 and producer information from the carrier component 100. It is appreciated that forms as used herein includes XML forms, readable forms, PDF forms, and/or the like. It is also appreciated that data that populates a license request form can be sent directly to a NIPR system to manage licenses. The forms component 214 can manipulate the license request form according to the downloaded state specific requirements. The forms component 214 automatically populates the license request form with the information of the system, and will flag information fields where there is missing information. A user interacts with the forms component 214 via the GUI component 104. The GUI component 104 may be implemented as software or hardware, as buttons, keys, a keyboard, including a microphone, or can be received from the user device. In one embodiment, the user can manipulate the GUI component 104 to select a state or states for licensing and select which LOAs to be licensed in. In another embodiment, the GUI component 104 can be manipulated to select from one or more insurance writing companies.

The forms component 214 can automate, at least in part, generation and population of license request forms useable in the same manner as conventional forms or electronic forms such as NIPR forms. In aspects, data provided in the producer database 102 can be mapped by the forms component 214 into a field in an electronic form. The electronic license request form can be sent to the producer registration system 202 which can file the license request form with the selected states.

The license manager 106 includes a mapping component 216. The mapping component 216 converts LOAs to state specific codes. The mapping component 216 retrieves the state specific requirements for codes and translates LOAs from the carrier format into the state format. In one embodiment, the translation is by way of a look up table. In one example, for most insurance carriers, the information is stored by the insurance carrier according to a set of standards maintained by the NIPR. In such a case, the mapping component 216 converts retrieved information from a carrier information standard into an information format associated with the state and/or producer registration system 202. In one embodiment, the mapping component 216 can convert license classes or LOAs to state specific license class codes. The converted information can then be populated into the license request form via the forms component 214. The license manager 106 can create batch reports that can depict each license appointment request and/or termination request in one report. The license manager 106 can create individual reports in the producer database 102 for each producer account.

The license manager 106 can send a completed license request form to the producer registration system 202. The producer registration system 202 can convert the license request form and the information included within to a state specific license request. The producer registration system 202 sends the state specific license request to the associated state licensing entity.

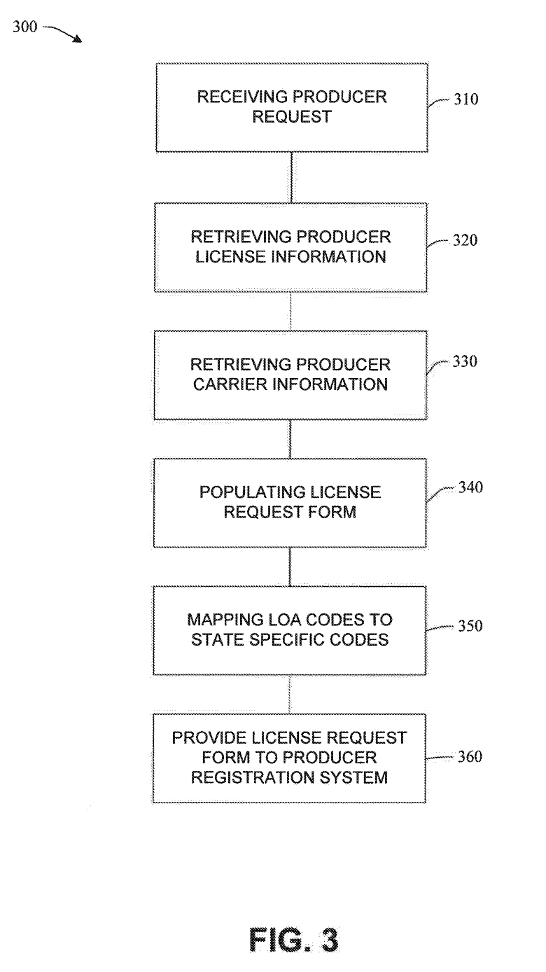

FIG. 3 illustrates a method 300 of automatically generating producer license requests as described herein, in accordance with aspects of the subject innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the subject innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject innovation.

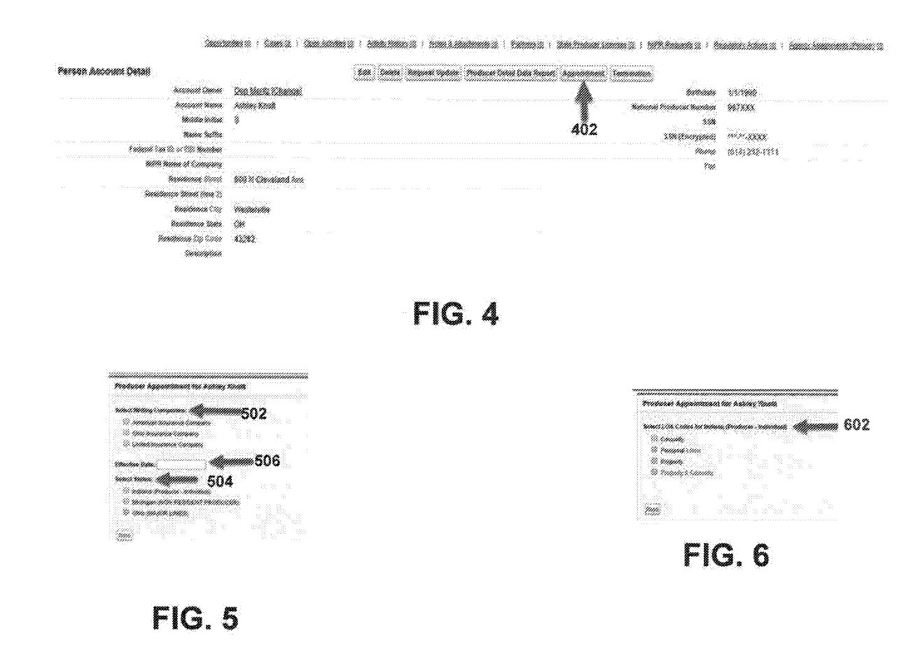

At 310, a producer request is received. For example, an insurance carrier intends to associate itself with a specific producer as its agent. The carrier, e.g. via the carrier component 100, begins a producer request. The producer request can include producer identification such as a producer number, states to be licensed, and lines of authority, i.e. types of insurance, for the producer to sell within the states. The producer request can be generated from the web application of the carrier component 100 through the producer's account entry (or “page”) in the producer database 102. FIGS. 4-6 depict screenshots for generating a producer request. FIG. 4 illustrates a screenshot of a producer account to begin a license appointment request. The license manager 106 integrates into the carrier component such that a license appointment button (and/or a report button and/or a termination button) 402 is presented to a user. FIG. 5 illustrates a screenshot of a dialog to select carriers 502 (writing companies) and states to be licensed 504. The dialog can also include a date 506 from which to search in the producer registration system 202. FIG. 6 illustrates a screenshot of a dialog to select LOAs 602 to request from the state. The LOAs are shown as text labels which can be converted to state specific number codes as described herein. In one embodiment, dialogs are created to confirm a producer request is sent to the producer registration system 202. In the case of a termination request, similar dialogs are generated to select which states, carriers, and/or LOAs for termination of an existing producer license.

At 320, producer license information is retrieved. In the example, the license manager 106 accesses a producer registration system 202 such as the NIPR as described above. The producer license information includes states licensed, license number, license class, active/passive status, license expiration date, license issue date, residency status, lines of authority, writing companies, or regulatory actions. The producer license information can also include state-specific requirements of information to be provided in order for a state to issue a license. The producer license information can be received from the NIPR in a compiled report that is sent to the license manager 106. In one embodiment, the producer license information is sent in an XML report or XML data and/or the like.

At 330, producer carrier information is retrieved. Continuing the example, the license manager 106 can analyze the producer license information to determine if there is missing information to complete a license request form for each state selected. If the license manager 106 determines missing information, the license manager 106 accesses the carrier component 100 to search the producer database 102 to retrieve the missing information. Alternatively, the license manager 106 can request that a user provide missing information. At 340, a license request form is populated with the producer license information and/or any missing information. The license request form can include an effective date for the license to be active and associate the producer with the carrier. In the example, a standardized license request form can be used which include general data fields of information that can be automatically filled. The standardized license request form can be adapted to include data fields for the state specific license requirements.

At 350, LOAs can be mapped to data fields in the license request form associated with state specific codes indicating types of insurance to sell. In the example, the carrier can select specific types of insurance for which the producer is to be licensed. In one embodiment, the carrier can select from colloquial descriptions of the insurance. State specific codes represent the type of insurance. However the codes can vary by state. For example, the code for casualty insurance is “36” for Indiana but it is “40” in Ohio. In one embodiment, the LOAs are mapped using a lookup table and/or database to associate the codes with the states to be licensed. At 360, the completed license request form is sent to the producer registration system 202. In the example, the license request form is sent over the network component 208 to the producer registration system 202. The producer registration system 202 can convert the license request form into a state specific form and forward the form to the associated state licensing entity which grants and/or denies producer licenses for the state. While for purposes of explanation, the specific example as used herein details a new producer getting licensed. A similar process can be used for license termination requests of a producer canceling a license or terminating a producer-carrier relationship.

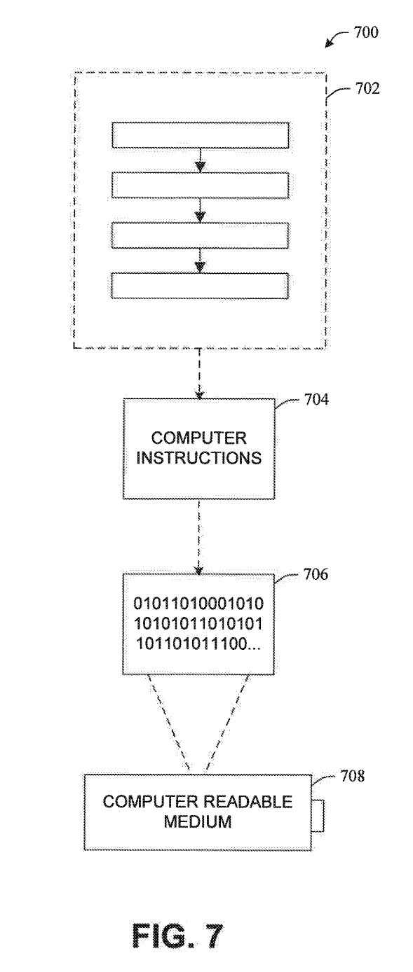

Still another embodiment can include a computer-readable medium comprising processor-executable instructions configured to implement one or more embodiments of the techniques presented herein. An embodiment of a computer-readable medium or a computer-readable device that is devised in these ways is illustrated in FIG. 7, wherein an implementation 700 comprises a computer-readable medium 708, such as a CD-R, DVD-R, flash drive, a platter of a hard disk drive, etc., on which is encoded computer-readable data 706. This computer-readable data 706, such as binary data comprising a plurality of zero's and one's as shown in 706, in turn comprises a set of computer instructions 704 configured to operate according to one or more of the principles set forth herein. In one such embodiment 700, the processor-executable computer instructions 704 is configured to perform a method 702, such as at least a portion of one or more of the methods described in connection with embodiments disclosed herein. In another embodiment, the processor-executable instructions 704 are configured to implement a system, such as at least a portion of one or more of the systems described in connection with embodiments disclosed herein. Many such computer-readable media can be devised by those of ordinary skill in the art that are configured to operate in accordance with the techniques presented herein.

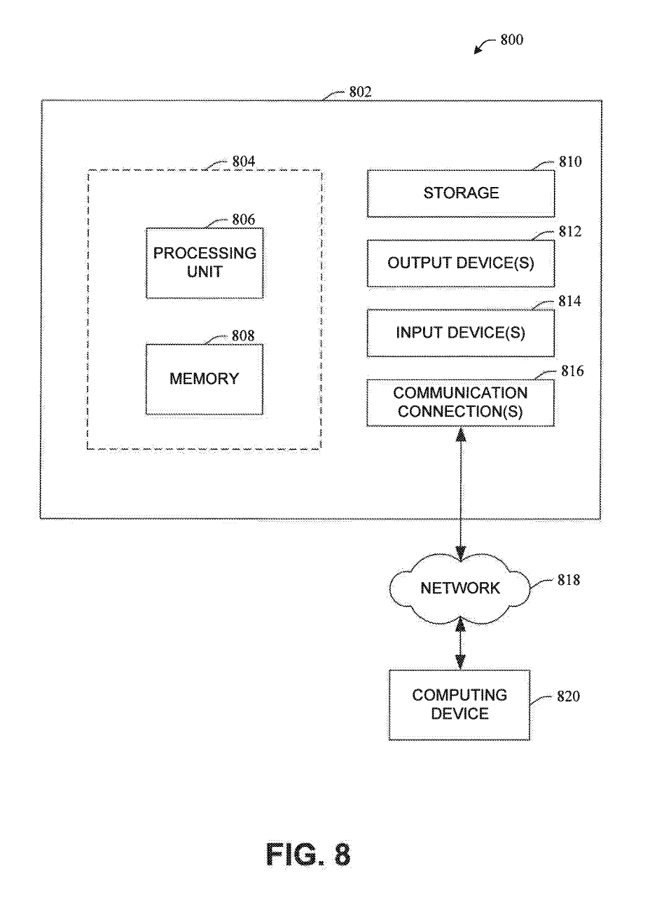

FIG. 8 and the following discussion provide a description of a suitable computing environment in which embodiments of one or more of the provisions set forth herein can be implemented. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 8 illustrates a system 800 comprising a computing device 802 configured to implement one or more embodiments provided herein. In one configuration, computing device 802 can include at least one processing unit 806 and memory 808. Depending on the exact configuration and type of computing device, memory 808 may be volatile, such as RAM, non-volatile, such as ROM, flash memory, etc., or some combination of the two. This configuration is illustrated in FIG. 8 by dashed line 804.

In these or other embodiments, device 802 can include additional features or functionality. For example, device 802 can also include additional storage such as removable storage or non-removable storage, including, but not limited to, magnetic storage, optical storage, and the like. Such additional storage is illustrated in FIG. 8 by storage 810. In some embodiments, computer readable instructions to implement one or more embodiments provided herein are in storage 810. Storage 810 can also store other computer readable instructions to implement an operating system, an application program, and the like. Computer readable instructions can be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media can be part of device 802.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 802 can include one or more input devices 814 such as keyboard, mouse, pen, voice input device, touch input device, infrared cameras, video input devices, or any other input device. One or more output devices 812 such as one or more displays, speakers, printers, or any other output device can also be included in device 802. The one or more input devices 814 and/or one or more output devices 812 can be connected to device 802 via a wired connection, wireless connection, or any combination thereof. In some embodiments, one or more input devices or output devices from another computing device can be used as input device(s) 814 or output device(s) 812 for computing device 802. Device 802 can also include one or more communication connections 816 that can facilitate communications with one or more other devices 820 by means of a communications network 818, which can be wired, wireless, or any combination thereof, and can include ad hoc networks, intranets, the Internet, or substantially any other communications network that can allow device 802 to communicate with at least one other computing device 820.

What has been described above includes examples of the subject innovation. It is, of course, not possible to describe every conceivable combination of components or methodologies for purposes of describing the subject innovation, but one of ordinary skill in the art may recognize that many further combinations and permutations of the subject innovation are possible. Accordingly, the subject innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a carrier component that manages information of a producer, a policy, and a customer; and
a license manager that facilitates administration of a plurality of producer licenses based on the information of the producer.

2. The system of claim 1, wherein the license manager comprises:
a retrieval component that receives existing producer license information from a producer registration system.

3. The system of claim 2, wherein the license manager comprises:
a forms component that populates a license request form with the received producer license information and producer information from the carrier component.

4. The system of claim 3, wherein the license request form is an appointment request form or a termination request form.

5. The system of claim 3, wherein the license manager comprises:
a mapping component that translates a line of authority of the carrier component to a state specific code.

6. The system of claim 4, wherein the mapping component translates the lines of authority according to a report generated from the producer registration system and a selected state in which the producer is to be licensed.

7. The system of claim 1, wherein the carrier component comprises:
a producer database that updates and stores the license information for producers.

8. The system of claim 1, wherein the license manager is integrated with the carrier component such that a graphical user interface, producer information, and processors are shared between the carrier component and the license manager.

9. The system of claim 1, wherein the information stored by the carrier component is information related to an insurance carrier.

10. A method, comprising:
receiving a producer request from a carrier;
retrieving producer license information about a producer from a producer registration system; and
populating a producer license request form with the retrieved producer license information.

11. The method of claim 10, comprising:
determining missing information to be included in a producer license request form to be sent to the producer registration system;
retrieving missing information from the carrier to include in the producer license request form; and
populating the producer license request form with the missing information.

12. The method of claim 11, wherein the determining missing information comprises:
receiving state specific information requirements from the producer registration system;
adapting the producer license request form to address the state specific information;
retrieving the state specific information from the carrier; and
populating the producer license request form with the retrieved state specific information.

13. The method of claim 10, wherein populating the producer license form comprises:
mapping a line of authority of the carrier to a state specific license class code.

14. The method of claim 10, comprising:
sending the producer license request form to the producer registration system over a network.

15. The method of claim 10, wherein the producer registration system converts the producer license request form into a state-specific license form and sends the state specific license form to a designated state entity.

16. The method of claim 10, wherein the producer license information includes one of states licensed, license number, license class, active/passive status, license expiration date, license issue date, residency status, lines of authority, writing companies, or regulatory actions.

17. The method of claim 10, further comprising:
associating the retrieved information with a producer account profile in the carrier; and
storing the retrieved information in a producer database.

18. A computer readable medium having instructions for controlling one or more processors, the instructions comprising:
receiving a selection of states, carrier writing companies, and lines of authority to request licensing within the selection of states;
retrieving producer license information in response to the selections associated with a producer account with a carrier and a producer registration system;
converting the lines of authority selection into state specific codes indicating the lines of authority; and
populating a license request with the producer license information and state specific codes.

19. The computer readable medium of claim 18, wherein the license request is in an XML format and sent to the producer registration system.

20. The computer readable medium of claim 18, the instructions comprising:
associating the retrieved information with a producer account profile of the carrier; and
storing the retrieved information in a producer database of the carrier.
